(19) United States
(12) Patent Application Publication
(10) Pub. No.: US 2018/0197095 A1
(43) Pub. Date: Jul. 12, 2018

(54) METHOD FOR IDENTIFYING COUNTRIES VULNERABLE TO UNREST

(71) Applicant: NICOLE SPONAUGLE, SPRINGFIELD, VA (US)

(72) Inventor: NICOLE SPONAUGLE, SPRINGFIELD, VA (US)

(21) Appl. No.: 15/806,297

(22) Filed: Nov. 7, 2017

Related U.S. Application Data
(63) Continuation-in-part of application No. 14/311,418, filed on Jun. 23, 2014, now abandoned.

(51) Int. Cl. G06N 5/04; G06N 7/00

(52) U.S. Cl. CPC G06N 5/048; G06N 7/005

(57) ABSTRACT

A method for measuring and scoring susceptibility to social unrest in a country or region is disclosed. Data is collected and entered into a computer regarding socioeconomic, political, demographic or other relevant conditions within the geographic area, and a set of key indicators of possible social unrest is provided. A computer standardizes he collected data across the indicators, calculates a performance level for each of the indicators, assigns a score for the collected data for each indicator within the geographic area based on the measurement of each indicator, and determines an overall score for the indicators.

### CROSS REFERENCE TO RELATED APPLICATION(S)

This application claims the benefit of U.S. application Ser. No. 14/311,418 (Sponaugle) entitled “A method for identifying countries vulnerable to unrest”, filed on Jun. 23, 2014 the subject matter of which is hereby incorporated herein by reference in its entirety.

### TECHNICAL FIELD OF THE INVENTION

The present invention relates to the field of risk analysis.

### BACKGROUND OF THE INVENTION

Existing private-sector, government and academic predictive instability models are currently unsatisfactory when it comes to accurately identifying countries that are susceptible to systemic and enduring social unrest. For example, these models were unable to accurately forecast the far-reaching impact of the Arab Spring, a wide-ranging series of societal revolutionary movements that resulted in the nearly simultaneous overthrow of several governments and sudden destabilization in the Middle East region.

The scope and impact of massive societal upheaval as part of the Arab Spring caught both public organizations and private businesses off guard. Countries that looked prosperous and stable on the macro-level (for example, Tunisia, Bahrain, and Oman) were nonetheless affected to varying degrees by social unrest. Additionally, a lack of understanding of the regional implications of the Arab Spring resulted in continuous surprises as unrest spilled over into other countries, destabilizing the North African & Middle Eastern regions. This situation created an uncertain diplomatic, security and investment environment.

The Stimson Center, a non-profit, non-partisan think tank, conducted a comprehensive review in 2011 of a broad range of academic, non-profit and private sector approaches and methodologies. Its overarching conclusion was that most experts were surprised by the extent, the timing, and the spread of societal unrest in the Middle East region leading up to the Arab Spring. The revolution from below that came about on the streets of the Middle East in late 2010/2011 was not anticipated, because few were looking for it and they had not focused on Tunisia, the country that served as the starting point. Further, few had anticipated a popular uprising that brought the middle and working class onto the streets, or were properly set up to follow popular or street sentiment. The Stimson Center's study further concluded that the commercial risk consulting sector, despite being specifically tasked to do so, had no more favorable results predicting the unrest than the public sector, stating that none of the risk consultants interviewed for its study claimed any insight into the nature and timing of Arab Spring events. To the extent that there were some correct predictions, these were primarily focused on Egypt and did not account for the possibility of widespread social unrest in other nations, such as Tunisia, Libya, or Syria. Further, these models provided little comprehensive understanding of societal trends on a cross-regional, much less global, level.

This failure to foresee or warn of such a wide-ranging event as the Arab Spring is problematic enough in a world where a thorough understanding of international situations is so critical. However, an extra dimension of concern is added when one considers that these events occurred in the Middle East, a strategic and resource-rich region that is perhaps the most studied, focused-upon and modeled area of the world for such clues to instability.

The implications of the continued failure to understand the institutional, societal, and economic conditions predisposing countries to such unrest can have dire consequences. Unease, for example, brought about by lack of understanding could cause the private and public sector to overreact in the event of future unrest. For example, the 2013 protests in Brazil and Turkey brought about more concern, uncertainty and speculations about_impending instability in a post-Arab Spring climate, concerns that proved to be unfounded, then they otherwise would have. Further, international resources like aid and diplomacy are limited, so that the most efficient use of these resources is critical.

Finally—as the description of the database underpinning this application, will conclusively show—the correlation between improvements in certain institutional, social, and economic conditions and domestic stability is not necessarily a positive and linear one. It can be counter-intuitive, but countries that experience improvements in these conditions may become temporarily more unstable than countries that do not experience such improvements. There can, in fact, be negative implications where one might expect positive ones. Lack of understanding of these subtle connections may result in misallocation of resources and the pursuit of governmental policies and investment strategies that promote rather than avert societal instability.

Current instability models and related indices also tend to have a narrow and discipline-specific focus that can miss important factors. Their focus tends to be exclusive on either particular economic sectors of interest to international corporations or on a top-down viewing of governmental centers of powers, ruling elites and key decision makers. Updating of these already-limited models on a less than annual basis may be insufficient as well. Another weakness of these models is that they have a country-specific focus, obtaining and analyzing data nation by nation.

Yet in the real world, and as the Arab Spring clearly showed, people of different nations interact with each other, and react to events and news in other countries. The national focus of data and modeling comes at the expense of understanding cross-regional or global trends, and vice versa. With the advent of the internet and other advanced communications, this trend is likely to increase, so that models that do not take this into account will become increasingly erroneous.

Another major factor affecting the likelihood of destabilizing unrest is its duration. The longer unrest continues, the more potential the unrest has to destabilize and spill over into other countries, yet this is rarely accounted for.

Furthermore, the current models tend to start with expert judgments which identify the countries that ought to be of concern. This approach can introduce expert bias early into the modeling process, thus limiting a model's utility to reducing strategic surprise (as was the case with Tunisia as the originator of the Arab Spring). Current models heavily rely on input by subject-matter experts/analysts to focus, scope, and support the models' operations.

Moreover, some models depend on subject-master expertise to identify the key indicators to be applied and to weigh them accordingly. This expert-driven approach seriously limits the predictive utility of current models as it reinforces existing biases and conclusions at the expense of identifying and recognizing the significance of newly-emerging factors.

Therefore, there is a need for a new method providing an improved bottom up perspective on a country or region's susceptibility to social unrest based first and foremost on empirical data vice expert judgments.

### SUMMARY

These and other objects are achieved by the method for identifying countries susceptible to severe societal unrest or overthrow herein. A country or set of countries (in one embodiment up to 179 countries) is evaluated against a group of key indicators (correlated to incidents of social unrest) which are assigned weights in accordance with their correlation. These are entered into a computer or similar processor to assess their respective susceptibility to systemic and enduring societal unrest.

Indicators and their respective weights are entered into the computer or other processor. The selection of these indicators is based on an in-depth empirical analysis of unrest events such as the Arab Spring and based on their historical presence in countries that have experienced societal upheaval to varying degrees.

Next, data is collected. The data can be collected by the computer, automatically by derived added application software and/or via a pre-arranged schedule, or manually by a user. The data is the latest data concerning the country or countries worldwide derived from an array of international and non-governmental organization. The processor standardizes the reported data across the indicators to adjust for differences in methods of reporting by organization and the type of data being conveyed.

The computer calculates a performance level for each of the indicators, by, for example, placing the measured score on a pre-determined scale, allowing for a country-by-country, regional and/or global comparison.

The computer measures each of the indicators for each country, countries, region or set of regions based on the most current data added for each indicator for that country, countries, region or set of regions, and assigns an indicator score based on the measurement. Following this, the score of the indicators for the country, countries, region or set of regions can be quantified together to determine an overall score reflecting a country, countries, region or set of regions' susceptibility to social instability.

After the computer arrives at an indicator score, the specific scores of a country, countries, region or set of regions across the multiple indicators can be compared to previous data and correlations between the indicators themselves. The computer calculates an instability metric and assigns it to the country, countries, region or set of regions. If the weighted score is compared to already-known scores for the country, countries, region or set of regions, the country, countries, region or set of regions can be placed in an appropriate position in a pre-determined scale of probable instability.

The weighted score can also be compared to a pre-determined “threshold score.” The more a country, countries, region or set of regions exceeds the “threshold score, the more susceptible the country, countries, region or set of regions is to social unrest. The computer can then determine how susceptible the country is to systemic and enduring social instability. Thereby, the capability of the computer for such purposes is enhanced.

Beyond a single country, the method renders a computer or computers capable of providing insight into the stability of multiple countries, an entire region, and/or global comparison. The method can be re-run for as many countries as desired. Additionally, the potential for intra- or inter-regional “spill over” or unrest moving from one place to another can be calculated and potential hot spots found in advance. The sustainability of the unrest can also be calculated and incorporated into the overall data picture, greatly enhancing computer functionality and correct calculating ability in this area.

### BRIEF DESCRIPTION OF THE DRAWINGS

FIG. 1 is a schematic diagram of an embodiment of the present invention.

FIG. 2 is a schematic diagram of another embodiment of the present invention.

FIG. 3 is a schematic diagram of a further embodiment of the present invention.

### DETAILED DESCRIPTION OF PREFERRED EMBODIMENTS

Other objects, features and advantages of the invention will become apparent from a consideration of the following detailed description and the accompanying drawings. The following descriptions are made referring to the figures, wherein like reference number refer to like features throughout this description.

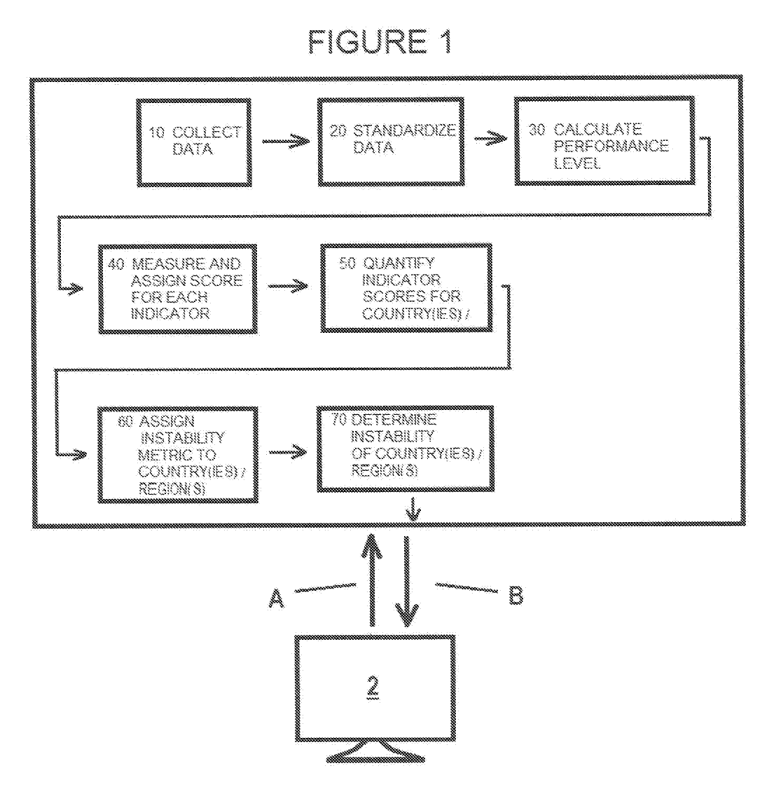

Several exemplary, though not exclusive, embodiments of the present invention are shown in FIGS. 1-3. Turning to FIG. 1, a method and system is shown that can be used to analyze multi-factor data and assess the probabilities of social unrest in a country, countries, region or set of regions due to socio-economic, political or other factors, or an interrelationship between these elements.

A computer 2 is provided. Herein, the term “computer” should be taken to mean a computer or other suitable electronic device known in the art that is capable of processing and working with data. This can include, but is not limited to, e.g., a personal computer, laptop, tablet, smartphone, server, or one or more of these devices in a linked or combined manner. The computer 2 without this system and method has a very limited or non-existent ability to predict systemic and enduring social unrest in any country or region. The ability of a computer in this regard is limited by the process or method programmed into it.

As shown by arrows “A” and “B”, the computer provides input and proceeds with the method towards a result, while simultaneously receiving information through the process, and adjusting accordingly to new data from the process in an interactive manner.

A group of key indicators of possible social unrest have been pre-selected and assigned weights. This can be completed by the computer 2. Further, specialized application software can be created for this task.

The indicators and weights of indicators are based upon the latest data, which can be entered into the computer 2, concerning countries that have or have not had civil unrest or revolution. The selection of these indicators is based on an in-depth empirical analysis of the Arab Spring and/or other unrest events and based on their quantified presence in countries that previously experienced social unrest. Those indicators found to have a correlation, negative or positive, to unrest such as general oppression (positive correlations) or access to fresh water (negative correlations) are included. Possible indicators found to have little or no correlation to social unrest, such as, e.g., life expectancy, are systematically excluded.

Indicator correlations are periodically updated based on new instances of social unrest and availability of the most currant data. This can be worked out through updating and calculation by the computer 2. In this embodiment, for example, an in-depth empirical study of the latest data from ten Arab Spring countries was undertaken of 16 possible indicators to determine which possible indicators correlated best to the real-world unrest, both positively and negatively.

Those that correlated in the Arab Spring countries were included and those that did not were not included. It has been found through such study that the indicators with the strongest correlations tend to be those concerning fundamental social, economic, and political conditions of a given country. In this embodiment, 14 key indicators have been found to have a correlation and are assigned a weight commensurate with their correlation. To increase the accuracy and functionality of the system, historical databases of information for the indicators of a number of countries (in this embodiment, 179 countries), dating back to 2010, can also be added to the computer 2 to provide more baseline data upon which to draw.

In this embodiment, 14 indicators were observed and are used. The weights of the indicators are based on the prevalence of each indicator in countries that experienced significant social unrest.

The empirically observed indicators in this embodiment are

(1) degree of oppression by the government,

(2) freshwater availability per capita,

(3) education level of the population,

(4) press freedom,

(5) proportion of youth to adult population, and

(6) annual rate of urban growth,

(7) arable land per capita,

(8) perceived corruption,

(9) level of accountability

(10) rule of law (and whether it's had a downward trend for the past three years

(11) poor performance on the economic freedom index

(12) a decline in government integrity (compared to the previous year)

(13) a decline in government spending (compared to the previous year)

(14) an increase in monetary freedom (compared to the previous year)

With the indicators set, the system and method are herein described. Continuing with FIG. 1, a first computational step of the method is the collection of data 10. On an annual basis, relevant data is released by reputable non-governmental, international, and governmental organizations regarding various conditions and factors in countries of interest, such as, e.g. socio-economic, political and demographic data.

The data is collected 10 for processing. The computer 2 can be programmed, such as with specialized application software or otherwise, to collect pre-determined data automatically and update it periodically. In this embodiment, the data that is being used for the method is publicly available and created by a variety of reputable sources such as the World Bank, the United Nations, and various non-governmental organizations such as Reporters Without Borders, Freedom House, The Heritage Foundation and Transparency International. Using such a broad range of source material helps control for any inherent institutional biases or organizational agendas within any single source. Each of these organizations has a well-established track record of publishing their data sets along with the methods used in collecting and evaluating the data sets.

Next, the computer 2 standardizes the reported data across the indicators 20. By standardization, it is meant that the computer 2 adjusts the data for differences in methods of reporting methodology by each organization and the type of data being conveyed. Standardization is achieved by determining an average value for each of the 14 indicators based on the performance of the countries in the database (179 in this embodiment) and, using this average value to establish four value ranges: “severe,” “poor,” “average,” and “above average.” After the indicator data is standardized across the range of data, each piece of data is entered into the appropriate indicator categories, thereby updating each category.

The computer 2 measures each indicator and assigns a weighted score to each based on the indicator's correlation to social unrest resulting from empirical analysis. Based on each weighted score, a performance level is calculated 30 for each of the indicators by the computer 2.

In this embodiment, the measured score is further placed at a point along a pre-determined scale for comparison. The pre-determined scale consists of the typical day-to-day socio-economic profiles (consisting of the 14 indicators) of countries that have experienced varying degrees of social unrest. The susceptibility to societal upheaval of a country, countries, region or set of regions is determined by how closely the score of the 14 indicators matches or departs from the typical socio-economic profile scores.

Next, the computer individually measures each of the indicators among as many countries or regions as desired (In this embodiment, up to 179 countries can be measured at once), based on the most current data, and a current indicator score based on the measurement is generated and assigned 40. For an example, data concerning the current level of government oppression in Tunisia would be quantified in accordance with the above-referenced value ranges (severe, poor, average, and above average) to provide a measurement of this indicator. Then a score based upon this measure provided 40.

Following this, the computer 2 can calculate an overall current score for the indicators of each country, countries, region or set of regions 50. If a further analysis is to be done of interrelationships of factors, the scoring of indicators 50 for each country, countries, region or set of regions is a preliminary step.

Upon the completion of indicator scoring 50, the user can use the computer 2 to identify individual countries, a group of countries, entire regions or multiple regions for further analysis. With the aid of the computer 2, the process allows for repeatable and consistent analysis at varying levels (e.g. on an individual, regional, and/or global scale). The system and method are capable of analyzing multiple countries at once.

The specific scores of a country, countries, region, or set of regions, or the globe across the multiple indicators relative to each other can be compared by the computer 2 to the respective country, countries, region, or set of regions, or globe's historical data on each of the indicators. This allows for longitudinal analysis for each indicator as well as cross-indicator analysis, drawing on the historical database that goes back to 2010.

As can be seen, that the database provides for this level of analysis of these many factors is significant, and is beyond the ability of effectiveness without the computer 2. In this embodiment, for example, the database contains almost 20,000 data points of country information and automatically ingests over 2500 data points every year, beyond the ability of typical human computation.

Other dimensions of analysis are typically required as well. For example, a particularly high instability score for a pair of indicators may exacerbate each other, so that a higher score than would otherwise be assigned to a country or region may be appropriate. On the other hand, there is not always a direct correlation between indicator scores and unrest. Empirical analysis has shown that improvements in particular individual indicators can have a temporarily destabilizing effect on a country's social stability. For example, testing of the indicators with the method herein has shown that the widely-held view that any socio-economic improvements increase the likelihood of social stability is not entirely correct. Improvement in some specific sectors without accompanying improvements in related sectors can, in fact, increase the chances for instability rather than decrease them. As an example, an increase in education without a corresponding improvement in press freedom or level of oppression can create social instability.

These relationships can be correlated to data on already-known relationships between indicators and be accounted for in calculation for unrest potential. Finding and using these correlations among these indicators to each other provides a more nuanced understanding of cross-sector trends and their implications on overall stability, as well as a more accurate model. Comparing data and automatically updating correlations further increases the ability of the computer 2 to address this problem Clearly, such multi-variable calculations would be extremely difficult or impossible without the computer 2 herein.

At this juncture, the computer 2 calculates an instability metric and assigns it to the countries, or a region or set of regions 60 in the dataset. This can be done in a number of ways. A weighted score for each country, countries, region or set of regions for the combination of indicators and weights can be compared either to already known weighted scores for multiple countries whose eventual levels of unrest are known, or compared to established quantitative threshold scores for countries that have had unrest or overthrow, thereby arriving at a metric 60.

If the weighted score is compared to already-known scores for countries, the country, countries, region or set of regions can be placed in an appropriate position in a pre-determined scale of probable instability. The scale, for example, could have the positions “stable,” “somewhat unstable,” and “very unstable.

The weighted score can also be compared to a pre-determined “threshold score.” The threshold would be calculated based on criteria from comparison to previously gathered data. For example, and in this embodiment, “threshold scores” are pre-determined based on indicator data from the Arab Spring countries. If the country, countries, region or set of regions' score is above the “threshold score,” this country, countries, region or set of regions has the strong potential for societal instability and should be closely monitored. The more a country, countries, region or set of regions exceeds the “threshold score, the more susceptible the country, countries, region or set of regions, is to social unrest.

Once the computer 2 has calculated a metric for a country, countries, region or set of regions 60, it can be determined how susceptible the country, countries, region or set of regions is to instability or overthrow 70 by comparison to other data or information. If a metric shows that a country, countries, region or set of regions may become unstable, this knowledge can be supplemented with expert analysis and opinion, or more specific data about that particular country, countries, region or set of regions. Because the analysis relies initially on empirical data and not on expert judgments, common biases from such reliance can be avoided, and the expertise and computations are better directed.

Beyond a single country, the method is capable of providing insight into the stability of multiple countries or even an entire region. The method can be re-run for as many countries as desired to gain the fullness of picture necessary. During testing of this method, up to 179 countries were successfully tested. Insight and knowledge into the stability of a region can be gained by calculating the stability of the countries in that region and either comparing this stability to other regions or to the same region at a time in the past, or both.

Further, up to a large number of countries analyzed can be ranked regionally as well as globally indicating their level of vulnerability to enduring instability, generally and relative to each other. As the specified international and non-governmental organizations publish their data sets, the system can, as described herein, pull in the latest data automatically, run through the process herein, compare the results to a prototypical unrest profile and dynamically update and rank the countries depending on how closely they match the profile. A country that matches the profile perfectly is assessed to be at high risk for enduring instability whereas a country that does not match the profile at all is assessed as stable. As noted previously, because of the complexity of these calculations, it would be either exceedingly difficult, or more likely impossible, to perform these tasks without computational means, such as the computer 2.

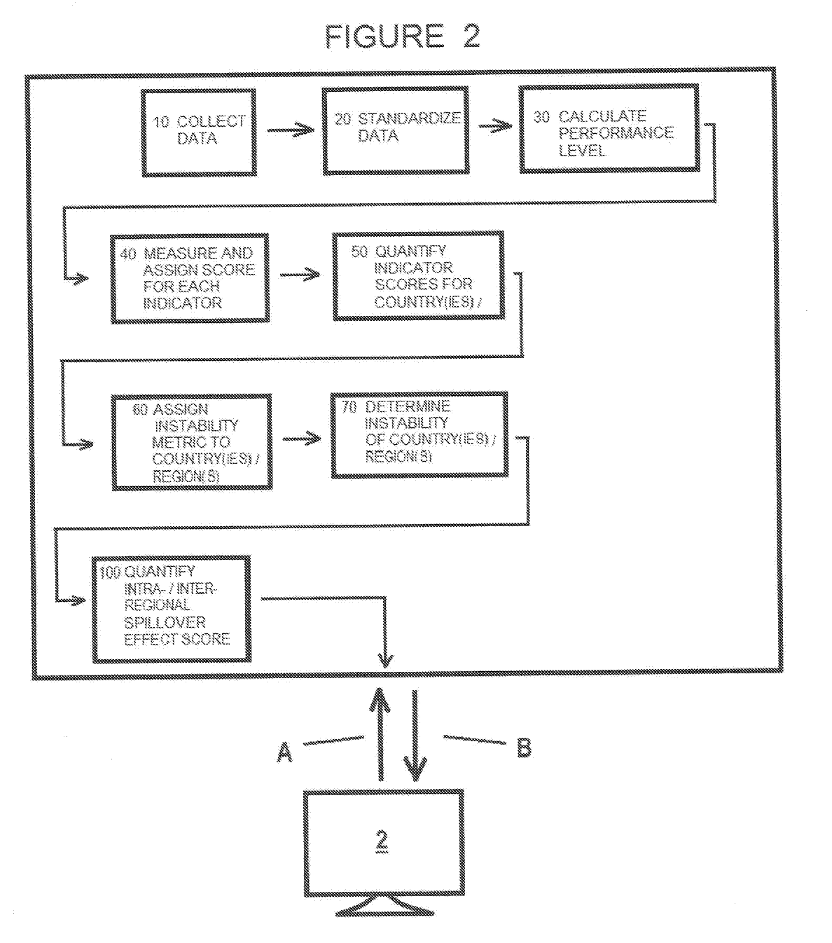

Turning to FIG. 2, the potential for “spill over” or unrest moving from one place to another can also be quantified and potential hot spots found in advance by the computer 2. After an instability score or placement on a scale is calculated for a country, countries, region or set of regions to determine instability 70, its spillover effect score or metric is quantified 100. The country, countries, region or set of regions is assessed by the computer 2 in terms for potential spillover effect to other countries and a “spillover effect” score is assigned 100, by comparing the score and country information to three pre-determined criteria which empirical findings have shown to have a direct correlation to spill over.

Spillover is generally the spread of unrest, planned or unplanned, from one country or region to another. For example, unrest over an oppressive and poorly serving government can move from one country to another, as it did during the fall of the Soviet Union which saw unrest spread from the USSRs Eastern European satellite states to the USSR itself. Spillover can occur intra-regionally, moving from one nation to another within a region, or inter-regionally, moving from one region to another. The Arab Spring, for example, had elements of both, spreading inter-regionally from North Africa to the Middle East region, and intra-regionally within both the North Africa and Middle East regions.

The three pre-determined criteria are

1) the country, countries, region or set of regions' assigned instability position or metric, as concluded in step 70,

2) the country, countries, region or set of regions, geographic proximity (i.e. shared borders) with other respective countries, region or set of regions that have also been quantified as susceptible to societal unrest, and

3) the amount of flow of people between any two involved susceptible countries or regions (from an immigration as well as emigration perspective).

The higher the first and bordering country or region's instability metrics, the greater the border and geographic proximity and the greater the flow of people between the susceptible respective countries or regions, the greater the potential is for unrest to move from one country or region to another. The lower any of these criteria are, the less potential for spillover or unrest there is.

The data from the country, countries, region or set of regions, is quantified and compared to the same kind of data quantified previously from that and/or other countries, regions or set of regions concerning the same three criterions. The higher the score, the more likely is the phenomenon of spillover.

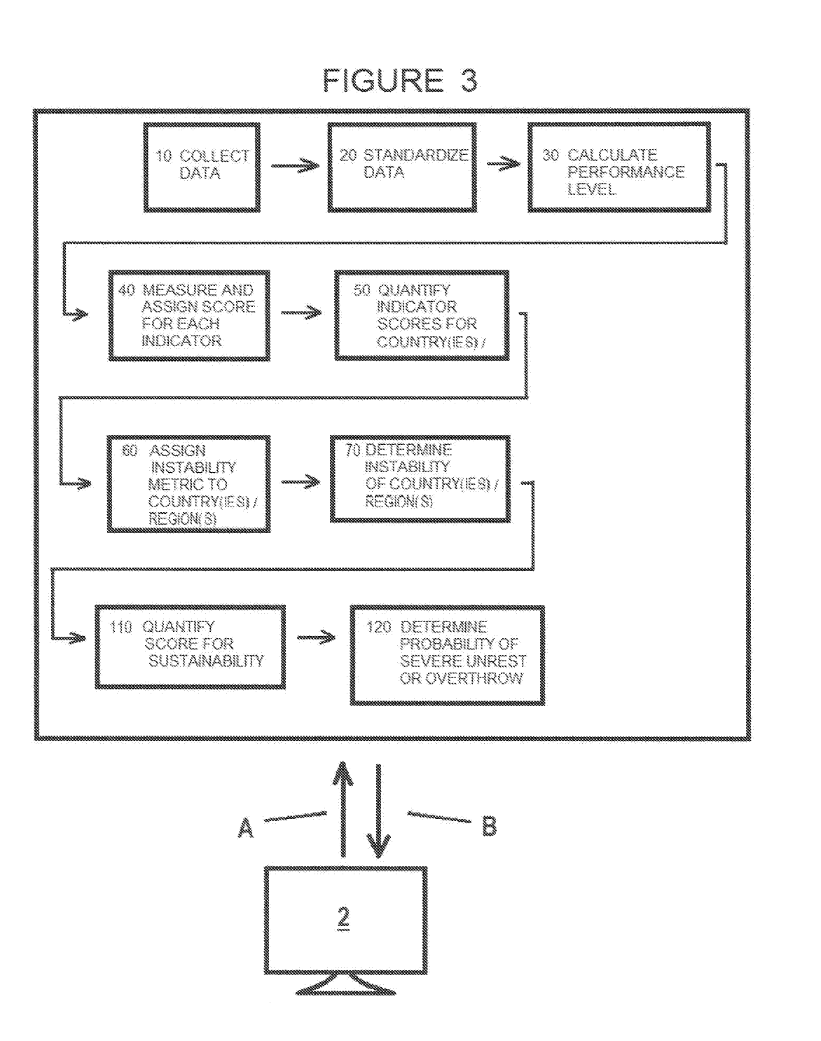

Turning to FIG. 3, another important factor affecting the depth of societal unrest and its potential to result in overthrow, the sustainability of unrest, can be calculated by the computer 2 and incorporated into the overall data picture as well. The more sustained unrest is projected to be, the more likely that it will result in overthrow of the government so that this score can provide important additional information.

After the overall probability of a country, countries, region or set of regions having societal unrest or instability based on indicator scores is quantified 70, if the country, countries, region or set of regions is identified as having strong potential for unrest, a secondary score for the sustainability, or length, of any possible unrest is quantified 110 to help determine the probable longevity of unrest.

In this step, the computer 2 compares quantified scores for the indicators for the country, countries, region or set of regions to specific indicator scores from data from previous instances of unrest that have been pre-identified as correlating to sustainability. The indicators, relationships between them and weighted scores of a country, countries, region or set of regions can be compared to previous data from that country, countries, region or set of regions and calibrated, comparing current conditions in that country, countries, region or set of regions, to those of respective countries, regions or set of regions which experienced prolonged or sporadic unrest and whether the societal unrest resulted in an overthrow of the governing authorities. For example, lowered educational opportunities and severe curbing of press freedom appear to correlate highly with sustained unrest, whereas high percentage of youth to adult population and above average annual rate of urban growth correlate highly with sporadic unrest. Based on this comparison, a score for sustainability is calculated and assigned 110.

Once a score is assigned 110, the probability of severe unrest or even overthrow of the government can be determined 120. Governments vulnerable to overthrow can be identified and intense analysis can be directed to any such developing situation. This method uniquely distinguishes and calculates between socio-economic conditions that fuel prolonged unrest and those that fuel sporadic unrest. This is of significant practical value because it provides the user with the nuanced understanding of which protests are likely to be destabilizing and which protests are unlikely to be so.

This measured and weighted method can be computed and applied on a regional or global scale. Multiple countries can be evaluated using this method, to gain a picture of the situation in a contiguous area, regionally, or even globally. Countries and regions worldwide can be monitored and scored to show whether, overall, each is moving toward or away from such social instability. As a result, a comprehensive overview can be provided of countries that are highly susceptible, somewhat susceptible and not susceptible (i.e. stable) to social unrest.

The data to be input into the indicator models run by the computer 2 is updated periodically as new data sets are published by the source organizations previously discussed.

### Case Study

This empirical method was tested to identify countries most susceptible to social unrest within a time frame of two years or less from testing. Data was gathered and standardized and the method was used to provide quantified metrics of instability for 179 countries. The countries were analyzed and scored compared to previously-known data for countries that actually experienced sustained or sporadic societal unrest. The results were impressive. The method was found to greatly increase the demonstrated predictive ability of the computer 2 by increasing the computer's accuracy in identifying countries that are at highest risk for social instability to an impressive level. All the countries that the method identified to be at highest risk for sustained social unrest experienced such unrest within 1-2 years, making the computer 2 a much more predictively accurate tool. These countries include Tunisia, Syria, Libya, Egypt, and Iraq. Moreover, countries such as Syria and Iraq were successfully identified by the computer 2 with this method as likely to be unstable in the near future, even though they were widely considered by experts in the field at the time as unlikely to experience widespread and sustained social unrest.

This method provides a number of benefits and advantages. It has been found, when applied, to provide 1-2 years of advanced warning regarding countries or regions primed for social unrest.

In addition to integrating institutional, social, and economic indicators to provide comprehensive rankings, the inventive method and system also allows the computer 2 to parse the findings in other ways specifically tailored to a user's needs. For instance, the user can filter the scored data according to sector (institutional, economic and societal), geographic scale (country, regional, or global) and by time series (longitudinal as well as cross-sectional).

The method herein, instead of insight into a single economic factor or country, can provide a global, regional or country-specific perspective, depending on the user's needs and preferences.

Trends within selected countries can also be tracked over time, thereby offering a contextual and systematic understanding of improving or worsening trends in indicator areas such as institutional resilience, the extent (or lack) of socio-economic opportunities, and resource pressures. It is also sufficiently nuanced to help successfully calculate whether improvements in particular sectors are sufficient, based on historical data, to have a stabilizing effect on a country or region as a whole, or may inadvertently destabilize it.

The method herein can further assist users with a comprehensive and nuanced understanding of the likely severity of unrest which—on the surface—may all look alike. This can prevent users from overreacting, mistaking a protest movement as more influential, far-reaching and destabilizing than it actually is.

The knowledge obtained by the method can be useful in numerous ways. First, it will aid users in making important resource allocation decisions. As an example, if the method shows that a country or area is at or near a threshold so that it is primed for enduring unrest, commercial enterprises can be warned that the country is unlikely to provide a suitable venture or investment climate, thereby averting substantial economic loss for these enterprises. On the other hand, identification of such countries may be helpful for the non-profit sector which may be specifically seeking to assist such countries with investment and aid allocation. It can also assist in creating improved policies towards these countries.

The method may also identify investment opportunities to users by highlighting sectors that are in need of improvement to stabilize a given country. In addition, it provides a cross-sectional perspective allowing the users to understand what the ramifications of investing in a particular sector are on the other sectors that are being monitored.

Finally, when operating in foreign cultures, it can be especially difficult for users to understand how sincere and effective a foreign government's policies are at ensuring domestic prosperity and stability. This method provides a quantitative evaluation of the sincerity and effectiveness of a country's policies in promoting resilience and socio-economic stability, assisting users in differentiating between meaningful reforms and superficial policies with little or no effect on stability.

By this simple method and device, a computer's capacity, and by extension its user, to effectively identify and predict countries or areas of potential societal unrest or revolution is greatly enhanced.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A Method for measuring and scoring susceptibility to social unrest in a geographic area, comprising the steps of:
providing a computational device,
collecting data to the computational device regarding socioeconomic, institutional, demographic or other relevant conditions within the geographic area,
providing a set of at least two key indicators of possible social unrest,
standardizing the collected date across the indicators with the computational device,
calculating a performance level for each of the indicators with the computational device,
measuring the collected data for each indicator within the geographic area and assigning a score based on the measurement of each indicator with the computational device, and
determining an overall score for the indicators with the computational device,
wherein the key indicators have a correlation to social unrest, and
wherein the correlation can be a positive or negative correlation, and
wherein the selection of the key indicators is based on in-depth empirical analysis of at least one unrest event.

2. A method according to claim 1, further comprising the steps of:
achieving standardization of data by determining an average value for each indicator and
establishing a set of at least four value ranges with the computational device,
wherein the four value ranges are severe, poor, average, and above average.

3. A method according to claim 1, further comprising the step of entering each piece of collected data into an appropriate indicator category after the data is standardized.

4. A method according to claim 1, further comprising the steps of:
calculating the performance level for each of the indicators by placing the measured score on a pre-determined scale with the computational device, and comparing the performance level of at least two countries against the pre-determined scale with the computational device.

5. A method according to claim 1, providing the further steps of assigning a weight to each key indicator.

6. A method according to claim 1, wherein at least two indicators have a correlation to each other that can mitigate or exacerbate a country's overall susceptibility to social instability.

7. A method according to claim 7, wherein the indicators are at least two of:
degree of oppression by the government,
freshwater availability per capita,
education level of the population,
press freedom,
proportion of youth to adult population,
annual rate of urban growth,
arable land per capita,
perceived corruption of the government,
level of accountability of the government,
level of rule of law,
poor performance on the economic freedom index,
a decline in government integrity as compared to the previous year,
a decline in government spending as compared to the previous year, and
an increase in monetary freedom as compared to the previous year.

8. A method according to claim 1, wherein the geographic area is at least one country, a single region or multiple regions, and comprising the further steps of:
selecting at least one country, a region, or multiple regions for analysis,
calculating an instability metric or score for the at least one country, region, or multiple regions with the computational device, and
determining the amount of susceptibility of the at least one country, regions, or multiple regions to instability or overthrow with the computational device.

9. A method according to claim 8, comprising the further step of comparing the specific scores of the at least one country, single region, or multiple regions across at least two indicators to selected correlations with the computational device to determine whether these correlations exacerbate or mitigate the at least one country, single region, or multiple regions susceptibility to social unrest,
wherein the specific correlations are empirically-established correlations between indicators that can have an exacerbating or mitigating effect on susceptibility to social unrest,
and recalculating the score based on the comparison to the correlations.

10. A method according to claim 8, wherein the instability metric or score for the at least one country, single region or multiple regions is calculated by:
comparing a weighted score for each country for at least two indicators to either a previously-known weighted score or a threshold score for at least one other country for past unrest with the computational device.

11. A method according to claim 8, comprising the further step of: placing the at least one country, single region or multiple regions in an appropriate position within a pre-determined scale of probable instability with the computational device.

12. A method according to claim 8, comprising the further steps of:
calculating the amount of instability of the at least one country, single region or multiple regions to obtain a stability level for the at least one country, single region or multiple regions, and either comparing the stability of the at least one country, single region or multiple regions to the stability of at least one other respective at least one country, single region or multiple regions, or to the same at least one country, single region or multiple regions, at a previous time with the computational device.

13. A method according to claim 8, comprising the further steps of:
providing at least a second respective at least one country, single region or multiple regions set, such that there is a first at least one country, single region or multiple regions set, and at least a second at least one country, single region or multiple regions set,
calculating a spillover effect score or metric for the first and second at least one country, single region or multiple regions set,
comparing the assigned spillover effect score or metric to a pre-determined threshold score with the computational device,
wherein the threshold score is determined based on related past data concerning instability and spillover, and
assigning a position on a scale regarding the potential for spillover with the computational device.

14. A method according to claim 13, wherein there is a positive correlation between a heightened spillover score and the likelihood of unrest to spread from the first at least one country, single region or multiple regions set to the second at least one country, single region or multiple regions set.

15. A method according to claim 13, wherein the spillover effect or metric from the first at least one country, single region or multiple regions set to the second at least second country, single region or multiple regions set is calculated with the computational device using any combination of:
the individually assigned instability score or metric for the two countries,
the geographic proximity or amount of shared border between the first at least one country, single region or multiple regions set with the respective second at least one country, single region or multiple regions set and the amount of flow of people between the two.

16. A method according to claim 8, further comprising the steps of:
calculating a secondary score for the sustainability of any possible unrest in the at least one country, single region or multiple region, with the computational device, and
determining the probability of severe unrest or overthrow of the government of the at least one country, single region or multiple regions by comparing the specific score for sustainability of unrest to specific indicator scores from data for previous instances of unrest in at least one country, single region or multiple regions with the computational device,
wherein the specific indicator scores have been pre-identified as correlating to severe unrest or overthrow.
